(19) United States
(12) Patent Application Publication
(10) Pub. No.: US 2004/0189679 A1
(43) Pub. Date: Sep. 30, 2004

(54) Video processor with a gamma correction memory of reduced size

(75) Inventors: Masahiro Ito, Kanagawa (JP); Takashi Watanabe, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD

(21) Appl. No.: 10/812,056

(22) Filed: Mar. 30, 2004

(30) Foreign Application Priority Data
Mar. 31, 2003 (JP) 2003-093100

(51) Int. Cl. G09G 5/10; G09G 5/02

(52) U.S. Cl. 345/690

(57) ABSTRACT

A video processor comprises a bit rate converter for converting an M-bit input video signal to an N-bit output video signal by retaining gray levels of the M-bit input video signal (where, N is smaller than M). A number of N-bit input gray levels are mapped in a gamma correction memory to a number of output gray levels. The output gray levels are distributed on a non-linear curve complementary to a non-linear curve on which gray levels of a display device are distributed. The memory delivers one of the output gray levels when the N-bit output video signal of the bit rate converter corresponds to one of the N-bit input gray levels. In one embodiment, the bit rate converter truncates lower significant bits of the M-bit video signal, represents the truncated bits by a different number of binary-1's, and distributes the binary-1's over a varying number of subsequent frames depending on the value of the truncated bits.

### BACKGROUND OF THE INVENTION

1. Field of the Invention

The present invention relates generally to video processors, and more specifically to a video processor for a display device whose gray levels are distributed on a non-linear curve. The present invention is particularly useful for small screen applications such as mobile terminals.

2. Description of the Related Art

Japanese Patent Publication 1997-50262 discloses a video processor using a dithering technique. According to the prior art video processor, the grayscale of an input video signal is gamma-corrected by a gamma correction memory (known as a look-up table) according to the gamma (grayscale) characteristic of a video display. The gamma-corrected video signal is input to a dithering circuit which compresses the number of bits representing the video signal so that it matches the number of bits used in the video display. If the input video signal is represented by ten bits, the gamma correction table must be implemented with 1,024 address locations or memory cells, each storing a 10-bit input grayscale code and a corresponding 10-bit output grayscale code. If color generation is required, a set of three color-component video sub-processors are required. Hence, a significant number of memory cells and power consumption are required for gamma correction.

### SUMMARY OF THE INVENTION

It is therefore an object of the present invention to provide a video processor which requires less memory and less power for gamma correction while retaining the gray levels of the input video signal.

According to the present invention, there is provided a video processor which comprises a bit rate converter for converting an M-bit input video signal to an N-bit output video signal by retaining gray levels of the M-bit input video signal (where, N is smaller than M), and a gamma correction memory in which a plurality of N-bit input gray levels are mapped to a plurality of output gray levels. The output gray levels are distributed on a non-linear curve complementary to a non-linear curve on which gray levels of a display device are distributed. The memory delivers one of the output gray levels when the N-bit output video signal of the bit rate converter corresponds to one of the N-bit input gray levels.

Preferably, the bit rate converter truncates lower significant bits of the M-bit video signal, represents the lower significant bits by a different number of binary-1's, and distributes the binary-1's over a varying number of subsequent frames depending on the truncated lower significant bits. Alternatively, the bit rate converter truncates lower significant bits of the M-bit video signal, leaving N bits, and causes the N bits to dither according to the truncated lower significant bits.

### BRIEF DESCRIPTION OF THE DRAWINGS

The present invention will be described in detail further with reference to the following drawings, in which:

FIG. 1 is a block diagram of a color video processor according to the present invention;

FIG. 2 is a block diagram of one embodiment of a bit rate converter of FIG. 1;

FIG. 3 is a block diagram of another embodiment of the bit rate converter; and

FIG. 4 is a block diagram of a modified form of the color video processor of the present invention.

### DETAILED DESCRIPTION

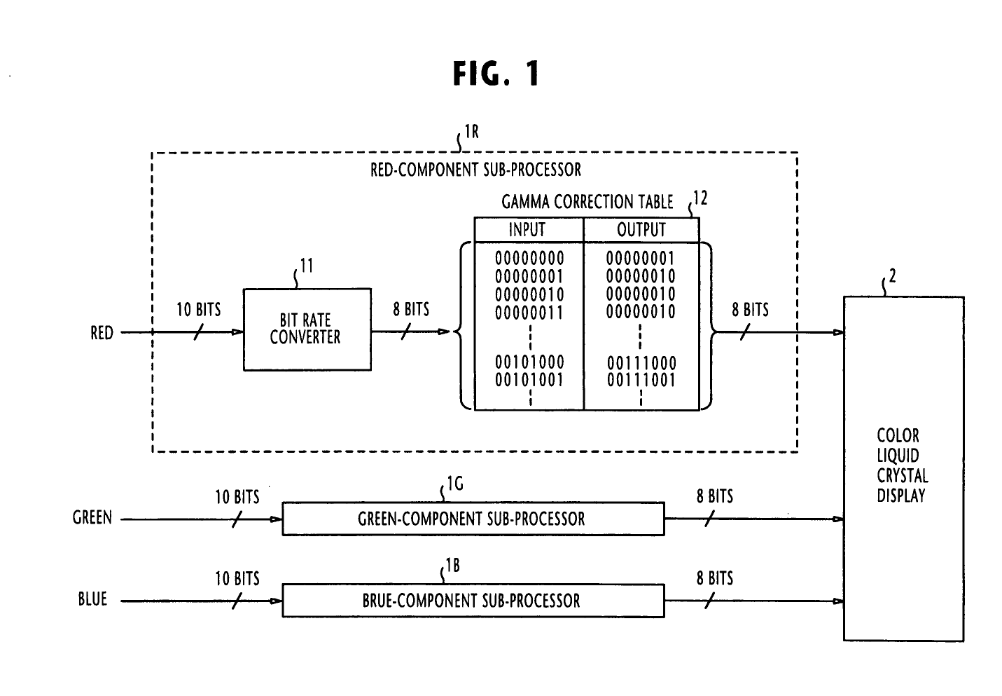

Referring now to FIG. 1, there is shown a color video processor according to one embodiment of the present invention. The color video processor comprises a set of red-component sub-processor 1R, a green-component sub-processor 1G and a blue-component sub-processor 1B. Since all the sub-processors are of identical construction, details of the red-component sub-processor only are illustrated. In this embodiment, the input video signal is represented by a number of bits greater than the number of bits representing the video input of a color liquid crystal display 2.

Each sub-processor includes a bit rate converter 11 for converting a 10-bit input sub-pixel data to an 8-bit output sub-pixel data. One embodiment of the bit rate conversion is implemented by using the basic principle of frame rate control. As described in detail later, this is achieved by truncating the lower two bits from the 10-bit input data, representing “11”, “10”, “01” and “00” of the lower two bits of the 10-bit input data by three binary-1's, two binary-1's, a binary-1 and a binary-0, respectively, and spreading these values over four successive frames. Each of the spread binary values is summed with the least significant bit of the truncated 8-bit data of the target frame. The 8-bit video output signal substantially retains the same scale of gray shades as the original gray scale of the 10-bit input video signal.

The output of the bit rate converter 11 is supplied to a gamma correction table 12 which provides gamma (γ) correction. In the gamma correction table, a plurality of 8-bit input codes are mapped to a plurality of corresponding 8-bit output codes. Normally, the gray levels in a liquid crystal display are distributed on a non-linear curve. In the grayscale conversion table 12, the linear input codes are converted to output codes representing gray levels which are distributed on a non-linear curve complementary to the non-linear curve of the liquid crystal display 2. After nonlinearity compensation by the gamma correction tables 12 of all sub-processors, 8-bit sub-pixel red-, green- and blue-component video output signals are combined in the color liquid crystal display 2 to form 8-bit color pixel data and displayed.

Since the input of correction table 12 is eight bits, the gamma correction table 12 can be implemented with 256 address locations (memory cells), instead of 1024 address locations which would otherwise be required if the input of the gamma correction table 12 is ten bits. In each color-component sub-processor, the memory size is reduced to 1/4 of the prior art. This represents a significant reduction when the color video processor is taken as a whole.

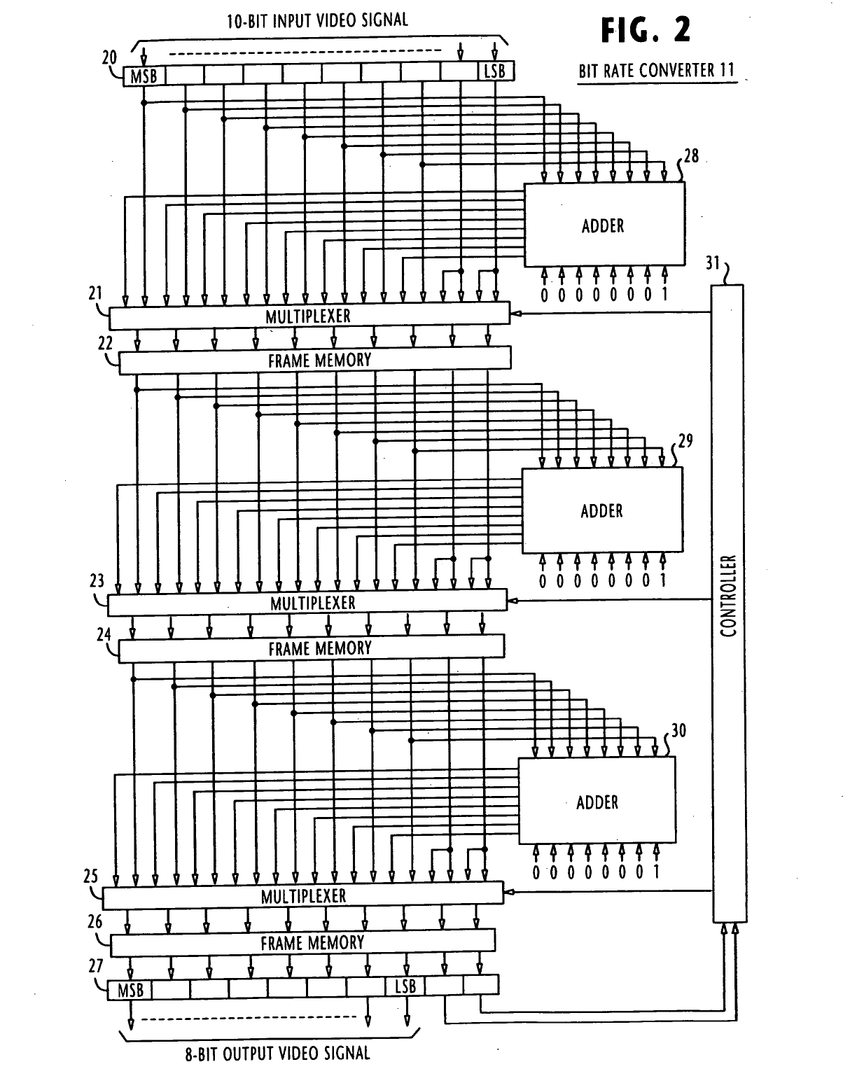

As shown in FIG. 2, the bit rate converter 11 of each color-component sub-processor comprises a 10-bit input register 20 for receiving 10 bits of each sub-pixel data of a color-component video signal in parallel. Eight bits of the input sub-pixel data are summed with “00000001” in an 8-bit adder 28. The 8-bit output of adder 28 is supplied to a multiplexer 21 to which the 10-bit input data of input register 20 is also supplied. Multiplexer 21 selects the 8-bit sum of adder 28 plus the original lower two bits from register 20 in response to a first control signal from a controller 31. In the absence of the first control signal, the multiplexer 21 selects the original 10-bit data from register 20. The 10-bit data selected by the multiplexer 21 is stored in a frame memory 22. At the end of a frame period, the frame memory 22 produces a 10-bit data.

In a similar manner, eight bits of the 10-bit data of frame memory 22 are summed with “00000001” in an 8-bit adder 29, which supplies its output to a multiplexer 23 to which the 10-bit data of frame memory 22 is also supplied. Multiplexer 23 selects the 8-bit sum of adder 29 plus the original. lower two bits from frame memory 22 in response to a second control signal from the controller 31. In the absence of the second control signal, the multiplexer 23 selects the 10-bit data from frame memory 22. The 10-bit data selected by the multiplexer 23 is stored in a frame memory 24.

Finally, the eight bits of the 10-bit data of frame memory 24 are summed with “00000001” in an 8-bit adder 30, which supplies its output to a multiplexer 25 to which the 10-bit data of frame memory 24 is also supplied. Multiplexer 25 selects the 8-bit sum of adder 30 plus the original lower two bits from frame memory 24 in response to a third control signal from the controller 31. In the absence of the third control signal, the multiplexer 25 selects the 10-bit data from frame memory 24. The 10-bit data selected by the multiplexer 25 is stored in a frame memory 26.

A 10-bit output register 27 is loaded with the 10-bit sub-pixel data from the frame memory 26 and delivers its higher 8 bits to the gamma correction table 12 and its lower 2 bits to the controller 31. Controller 31 produces the first, second and third control signals at the same time when the lower two bits of register 27 are “11”. When the lower two bits are “10”, the controller 31 simultaneously produces the second and third control signals. When the lower two bits are “01”, the controller 31 produces the third signal only.

Therefore, when a 10-bit sub-pixel data of a first frame is stored in the frame memory 26, second and third frames will be subsequently stored in the frame memories 24 and 22, respectively, and 10-bit sub-pixel data of a fourth frame will be stored in the input register 20.

Assume that a first frame is stored in the frame memory 26. If the lower two bits of the 10-bit data in the output register 27 are “01”, a binary-1 is summed with only one subsequent frame (i.e., the second frame). If the lower two bits of the output register are “10”, binary-1's are summed with two consecutive frames (i.e., second and third frames). If the lower two bits of the output register are “11”, binary-1's are summed with three consecutive frames (i.e., second, third and fourth frames). If the lower two bits of the first frame are “00”, no addition is provided in the bit rate converter.

Therefore, the lower two bits of the original 10-bit data are represented by a corresponding number of binary-1's and each of the representing binary-1's is distributed to one of subsequent frames.

By distributing the binary-1's representing the lower two bits over four consecutive frame periods in a manner just described, gray levels of 0.0, 0.25, 0.5 and 0.75 are generated when the lower bits are “00”, “01”, “10” and “11”, respectively. Viewer's eyes will average out the luminance (or darkness) of a pixel so that the individual pixel will show as gray.

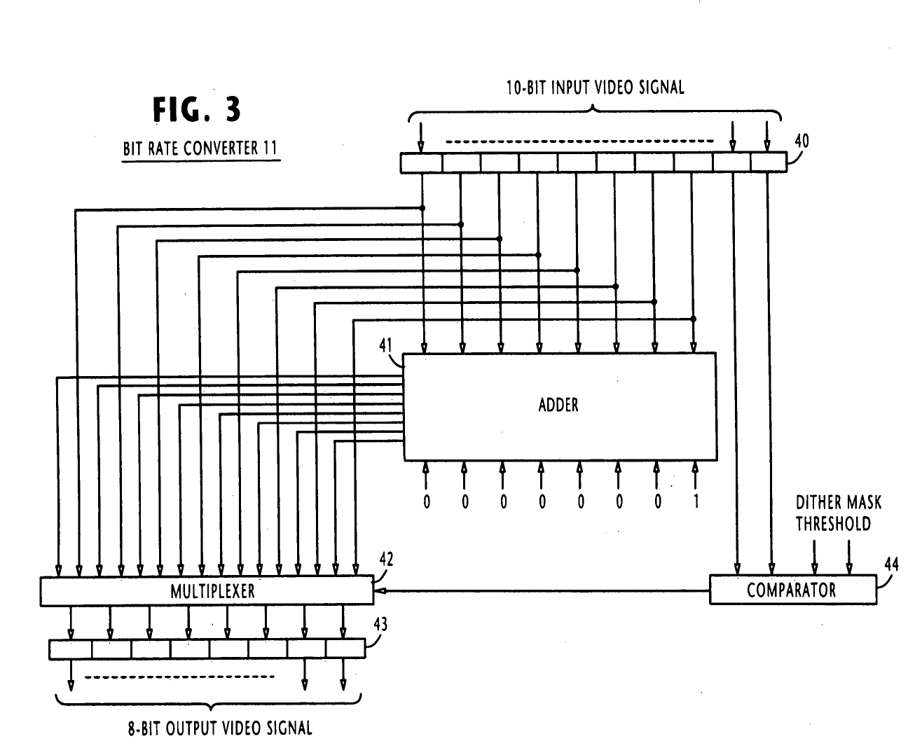

The bit-rate conversion without reducing the gray levels can also be implemented by dithering. As shown in FIG. 3, the bit rate converter 11 of dithering type includes an input register 40 for receiving a 10-bit sub-pixel data. An 8-bit adder 41 provides addition of the higher eight significant bits of the register 40 with “00000001” and supplies the sum to a multiplexer 42 to which the higher eight bits of the register 40 are also applied. The lower two bits of the input register are applied to a comparator 44 for comparison with a dither mask threshold. The output of the comparator 44 is used by the multiplexer as a control signal for selecting its input data. If the lower two bits are greater than the threshold, the multiplexer 42 selects the outputs of adder 41. Otherwise, the multiplexer selects the 8-bit output of register 40. The 8-bit sub-pixel data selected by the multiplexer 42 is transferred to an output register 43 for application to the gamma correction table 12.

The addition of a binary-1 by the adder 41 produces a dot pattern which appears substantially at random in response to the lower two bits of the 10-bit video input signal. Grayscale effect can then be detected by viewer's eyes.

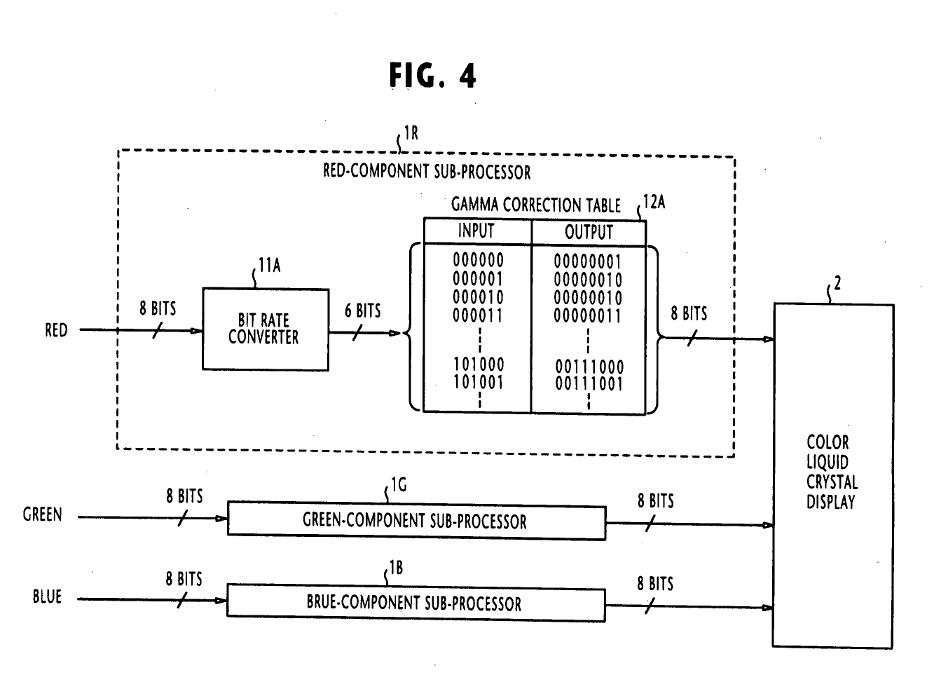

FIG. 4 is a block diagram of a modification of the present invention, which differs from the embodiment of FIG. 1 in that the input color video signal is represented by the same number of bits as the video input of the color liquid crystal display 2. Specifically, the bit rate converter 1A receives 8-bit color-component sub-pixel data and converts it to 6-bit output data in a manner as described above. The 6-bit data is supplied to the gamma correction table 12A in which a plurality of 6-bit codes are mapped to a plurality of interpolated 8-bit codes. Similar to the previous embodiment, the gamma correction table 12A can be implemented with a reduced number of memory addresses.

What is claimed is:

1. A video processor comprising:
a bit rate converter for converting an M-bit input video signal to an N-bit output video signal by retaining gray levels of the M-bit input video signal, wherein N is smaller than M; and
a gamma correction memory in which a plurality of N-bit input gray levels are mapped to a plurality of output gray levels which are distributed on a non-linear curve complementary to a non-linear curve on which gray levels of a display device are distributed,
said memory delivering one of the output gray levels when said N-bit output video signal of said bit rate converter corresponds to one of the N-bit input gray levels.

2. The video processor of claim 1, wherein said output gray levels are represented by N bits.

3. The video processor of claim 1, wherein said output gray scale values are interpolated gray levels of the input gray levels.

4. The video processor of claim 1, wherein said output gray scale values are represented by M bits.

5. The video processor of claim 1, wherein said bit rate converter comprises means for truncating lower significant bits of the M-bit video signal, representing the truncated lower significant bits by a different number of binary-1's, and distributing the binary-1's over a varying number of subsequent frames depending on the truncated lower significant bits.

6. The video processor of claim 1, wherein said bit rate converter comprises:
a first adder for summing a binary-1 to the least significant bit position of higher N bits of the M-bit input video signal;
a first multiplexer for selecting an output of said first adder or said higher N bits in response to a first control signal;
a first frame memory for storing an output of said first multiplexer;
a second adder for summing a binary-1 to an output of the first frame memory;
a second multiplexer for selecting an output of said second adder or an output of said first frame memory in response to a second control signal;
a second frame memory for storing an output of said second multiplexer;
a third adder for summing a binary-1 to an output of the second frame memory;
a third multiplexer for selecting an output of said third adder or an output of said second frame memory in response to a third control signal;
a third frame memory for storing an output of said third multiplexer; and
control means for producing said first control signal only, said first and second control signals simultaneously, or said first, second and third control signals simultaneously, depending on the truncated lower significant bits.

7. The video processor of claim 1, wherein said bit rate converter comprises means for truncating lower significant bits of the M-bit video signal so that N bits are left in the input video signal, and dithering the N bits according to the truncated lower significant bits.

8. The video processor of claim 1, wherein said bit rate converter comprises:
an adder for summing a binary-1 to higher N bits of the M-bit input video signal;
a multiplexer for selecting an output of said adder or said higher N bits of the M-bit input video signal in response to a control signal; and
a comparator for producing said control signal by making a comparison between lower significant bits of said M-bit input video signal and a threshold value.
